(19) United States
(12) Patent Application Publication
(10) Pub. No.: US 2007/0214491 A1
(43) Pub. Date: Sep. 13, 2007

(54) INTERACTIVE SECURITY CONTROL SYSTEM AND METHOD WITH AUTOMATED ORDER SUBMISSION AND APPROVAL PROCESS

(75) Inventors: Scott M. Serani, Broomfield, CO (US); Leslie S. McMillin, Littleton, CO (US); Charles D. Blish, Arvada, CO (US)

Correspondence Address: WOOD, HERRON & EVANS, LLP, 2700 CAREW TOWER, 441 VINE STREET, CINCINNATI, OH, 45202, US

(73) Assignee: SHIELD SECURITY SYSTEMS, L.L.C., Denver, CO (US)

(21) Appl. No.: 11/679,930

(22) Filed: Feb. 28, 2007

Related U.S. Application Data
(60) Provisional application No. 60/743,418, filed on Mar. 7, 2006.

(51) Int. Cl. H04L 9/00

(52) U.S. Cl. 726/1

(57) ABSTRACT

An interactive system and method for security management, the system accessible via a communications network by a plurality of DB-Users and adapted to manage a security system associated with places physically protected by corresponding security components used to control physical entry to the places. The system comprises at least one searchable database configured to store information on the DB-Users and the security components. The Software is configured to recognize different DB-User profiles established based on the information for different DB-Users. Each profile may define an authority level of the corresponding DB-User. A feature may be provided requiring at least one approver, in addition to that DB-User, for submitting an order for one or more of the components of the security system.

The present application claims the benefit of U.S. Provisional Application Ser. No. 60/743,418, filed Mar. 7, 2006, the disclosure of which is fully incorporated by reference herein.

### BACKGROUND

This invention relates generally to entry control systems and more particularly relates to an interactive method and system for controlling the management of a physical security system, whether it is key-based or based on other types of security devices.

Key management programs have been in existence for many years. First came the invention of pin tumbler lock cylinders that gave security professionals the ability to alter the internal configuration of the pins inside the cylinder and cut related keys to that combination in order to effect a change in Users having access to a particular Location. Following that invention came the development of interchangeable cores that allowed program managers to physically move the location of an existing lock cylinder to a different location and thus again achieve the ability to control the access of users into various locations.

Initially, program managers began seeking control over the ability to duplicate keys and thus minimize the inherent security breach of, for example, five keys turning into six keys without proper authority. Manufacturers in the industry focused attention on various forms of restricting access to key blanks in order to offer program managers the confidence that keys could not be duplicated without a program manager's specific approval.

InstaKey Lock Corporation of Denver, Colo. previously devised a lock cylinder that permits authorized users to re-key each lock when necessary. With this cylinder, when a key is lost or stolen, it is necessary only to insert a replacement key into the lock, turn it 180 degrees and remove it along with a wafer from the lock cylinder's pinning. Upon removal of the wafer, only new keys matched to the replacement key will now open the lock. Such a rekeying operation is hereinafter referred to as a “step change.” The operation can be repeated a preset number of times depending upon the number of wafers in the cylinder that are removable by different replacement keys and then the cylinder can be easily re-pinned through another designed sequence of steps. In this manner, or in other re-keying operations, one can change from “step 1” to “step 2” to “step 3,” etc. each time re-keying is necessary.

A software based system has been developed and implemented by Instakey Lock Corporation which is capable of using the Internet and/or intranet in conjunction with a relational database in monitoring and recording the information flow and data related to an access control or security system so that immediate attention and correction can be given to a problem that may arise virtually at any time in different parts of the world. This data processing system, described in U.S. patent application Ser. No. 09/925,672, filed on Aug. 10, 2001, now U.S. Pat. No. 7,120,935, dynamically links entry control devices, such as a key and/or lock cylinder, to users to locations such that access to each location is controlled and known on a real time basis. The data processing system is capable of maintaining current and historical data on each of the three primary components (devices, locations and users) so that the complete history of any component is accessible to authorized users and complete security is established in order to control access to specific data and information on a “need-to-know” basis.

Many organizations have complex security systems with many individual locations that must be physically secured, and many users both in terms of those persons using security devices (e.g., keys) to enter secured locations, and those persons using the database that stores information on one or both types of users, locations and/or devices. One of many examples is a college campus setting that has a dormitory system with thousands of keys distributed to students and employees of the college. Although smaller, less complex security systems can have similar issues, it may be especially cumbersome and unnecessary in a large scale setting to have centralized administration of all functions in a database management system for a security system.

### SUMMARY

The present invention provides an interactive system and method for security management with various features related to ordering security system components. The system is accessible via a communications network by a plurality of DB-Users and is adapted to manage a security system associated with places physically protected by corresponding security components used to control physical entry to the places. Such components may, for example, be Devices (as defined herein) or any other components necessary or desirable to add to the security system or maintain the security system. The system may generally comprise at least one searchable database configured to store information on the DB-Users and the security components. Software is configured to recognize different profiles established based on the information for different DB-Users. Each profile defines an authority level of the corresponding DB-User including, for at least one of the DB-Users, the requirement for at least one approver other than that DB-User. In this manner, the order submission by that DB-User and the approval of the approver are necessary before procuring one or more of the components of the security system.

The Software may be configured to direct the order through a plurality of separate approvers. For example, this plurality of separate approvers may be established in a hierarchy such that a first one of the approvers must approve the order before the order is forwarded on to a second one of the approvers. Alternatively, or in addition, multiple approvers may be established in a horizontal manner such that approval is requested from all such approvers at one time. The information stored in the database on the DB-Users having ordering privileges may also define many types of different privileges including, but not limited to, which Devices and/or other components may be ordered by each DB-User, the number of such Devices and/or components, etc. It will also be understood that a system may have a large number of DB-Users and that not all DB-Users may have ordering privileges for components of the security system.

In other aspects, the Software may be configured to allow Device or other component ordering privileges to be established for each of the plurality of DB-Users (although this plurality of DB-Users may not be all DB-Users of the system as noted above). The component ordering privileges may include the need for at least one additional approver to whom the order is automatically routed prior to allowing the DB-User to submit the order for procurement. It will be understood that submitting the order for procurement may involve actually submitting the order for production of the component or submitting the order for purchase or other procurement. In other features of the system, the Software may be configured to automatically remind the approver or approvers of each order awaiting approval so as to help speed the order through the ordering process. The Software may also be configured to maintain real time information on the status of each order. The Software may also be configured to produce reports with statistical information concerning, as examples, at least one of: the orders placed by one or more DB-Users, time intervals within one or more ordering processes, the orders placed during a particular time period, the number of orders placed by Location, Devices ordered for particular Device-Users, and/or combinations thereof.

In another aspect of the invention, a method is provided for managing access to information concerning a security system by a plurality of DB-Users. The security system is configured to physically secure a plurality of places with a corresponding plurality of security components used to control physical entry to the places. The method generally can comprise using Software to place an order for at least one of the components of the security system in accordance with authority granted in a security component ordering profile stored in a database. The method further involves using the Software to forward the order on to at least one approver for approving the order prior to submitting the order for procurement.

The method can further comprise using the Software to forward the order on to a plurality of approvers for approving the order prior to submitting the order for procurement. Various other combinations of the additional features of the system, as discussed above, may alternatively or in addition be used in carrying out the methods in accordance with this invention.

The above and other objects, advantages and features of the present invention will become more readily appreciated and understood from a consideration of the following detailed description of illustrative embodiments when taken together with the accompanying drawings.

### BRIEF DESCRIPTION OF THE DRAWINGS

FIG. 1 is a flow diagram of a preferred process for gaining access to a database in accordance with the present invention;

FIG. 2 is another flow diagram illustrating the manner in which a session has ended in accordance with the present invention;

FIG. 3 is a flow diagram representing the process of confirming a selection from the main menu followed by verification of authority;

FIG. 4 is a flow diagram directed to the decision process involved in determining the type of look-up desired and verification that the User has authority for such look-up;

FIG. 5 is a flow diagram representing a look-up device;

FIGS. 6 to 9 are flow diagrams representing other look-up possibilities;

FIG. 10 is a flow diagram for adding functions;

FIG. 11 is a flow diagram directed to the addition of keys or other entry control devices;

FIG. 12 is a flow diagram representing the addition of a Location;

FIG. 13 is a flow diagram representing the addition of a User to access the system;

FIGS. 14 and 14A comprise a flow diagram representing the placing of an order for a new key or entry control device;

FIG. 15 is a flow diagram representing the addition of a new master key chart into the database for a specific application;

FIG. 16 is a flow diagram for deleting functions from a system;

FIG. 17 is a flow diagram of routine modifications to the system;

FIG. 18 is a flow diagram of routines for editing reports;

FIG. 19 is a flow diagram of the initial portion of miscellaneous processes built into the data base and verification that the User has authority to select particular routines;

FIG. 20 is a flow diagram of the steps followed to permit a User to modify profiles of other Users;

FIG. 21 is a flow diagram of the steps followed to alter screen privileges for each User;

FIG. 22 is a flow diagram of routines built into the data base by which a User can modify a specific screen;

FIG. 23 is a flow diagram of a User validation process;

FIG. 24 is a profile table illustrating levels of security in an access control system in accordance with the present invention; and

FIG. 25 illustrates examples of different levels of security within the access control system of the present invention.

### DETAILED DESCRIPTION OF ILLUSTRATIVE EMBODIMENTS

Various terms employed herein have the following meanings:

“Device(s)” are those tangible/intangible objects, items or components of a security system which allow an authorized Device-User to gain physical access to a geographic Location (or alternatively, deny access to an unauthorized User). Devices may be tangible components containing encoded criteria which are assigned to and in possession of a Device-User but are independent of the Device-User. Such Devices may be portable in that they may be moved from Device-User to Device-User or reconfigured to a different encoded criteria, such as mechanical keys, cards such as those utilized in a card access or ATM system, Dallas Chips or other electronic signaling mechanisms, bar codes, or similar components. Devices may be intangible components in the form of information assigned to and in possession of a Device-User, such as code number(s) utilized in keypad/combination lock processes, PIN numbers utilized in a variety of security and ATM systems, code words or phrases, or other intangible informational components used for similar purposes. Devices may be tangible and irrevocable features of the Device-User thus performing the function of identification (encoding), such as, fingerprints, retina scans, voice patterns, and the like.

A “Location” comprises one or more places physically protected by a security mechanism (such as one or more mechanical or electronic locks) and configured to allow entry of a Device-User to the place or places when the Device-User uses a properly configured Device.

“User” is an individual involved with, dependent upon, or utilizing security data composed of Devices, Locations, and Users.

(i) “Device-User” is one type of User which is permitted entry to defined Locations by way of the issuance and configuration of Device(s) in the possession of that Device-User, such as an employee granted access to a department with a key, a contractor having access to a front door with a card, a driver opening a gate by way of a padlock combination, etc.

(ii) “Database-User” (DB-User) is an individual specifically authorized to access and/or configure data as it relates to the integration and usage of the security system, such as a security system's database manager, a manager allowed to view access privileges to a Location, remote security personnel accessing security information in the security system, third party vendor managing/supporting technical aspects, etc. A DB-User may or may not be a Device-User and a Device-User may or may not be a DB-User.

“Software” means computerized elements (such as hardware, software, communications, etc.) designed for the primary purpose of integrating and managing Devices, Users, and Locations to achieve a desired security effect. Software is a relational database structure linking Users to Devices to Locations in a dynamic environment so as to provide access as required and/or mandated by a security program. Software may be designed to be used at a User's own host computer directly or a third party host computer remotely (via a User's own network or the Internet). Software is used by a DB-User to perform various functions in accordance with one or more aspects of the invention.

“View” is the ability to see system database interrelationships. For example, a security guard may be authorized to view which Device-Users are allowed access to a particular Location, a department manager may be authorized to create a report of all outstanding Devices to his department, a facilities manager may be granted privileges to view all keys issued to contractors, or a loss prevention professional or auditor may be granted access to all issued Devices to all Device-Users in order to confirm data integrity, etc.

“Add” is the ability to physically make additions to the database (new Devices, Device-Users or DB-Users, or Locations). For example, the ability to place an order of a new Device to be issued to a new Device-User, authorization to create all the data necessary for a new Location and thus all the Devices and Device-Users to be associated with that Location, and security clearance to add additional DB-Users to the access control system.

“Modify” is the ability to modify existing database entries. For example, an individual in charge of “temporary Devices” (keys identified as temporary issuance keys) may record the handling of a loaner key to a temporary Device-User and/or the receipt of that loaner key when returned, the ability to record a Device as lost/stolen/found, record the transfer of a Device from one Device-User to another, ability to alter existing Location and/or User data (i.e. type of hardware on a door, PIN number at an ATM or telephone number of a User), and a security director authorized to make changes to the security access of Software by DB-User (View, Modify, Add, Delete).

“Delete” is the ability to physically delete existing database entries. For example, a Location no longer part of the User's security program needs all data related to that Location purged from the database.

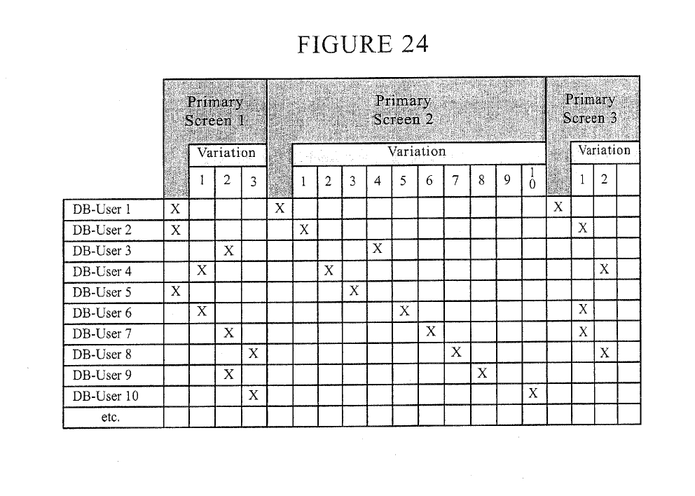

“Profile Table” is a parameter driven function, as shown in FIG. 24, that links every display screen of the Software to each DB-User authorized to access a given database. By defining a DB-User's privileges by screen and by function (View, Add, Delete, Modify) and further defining those privileges to all or some portion of a database, those with a need to know can reach the data as authorized. As represented by “X” in FIG. 24, by turning on privileges (V=View, A=Add, D=Delete, M=Modify) by segment of data (a=all, s=some portion) for every screen display (window), access to the data can be fully controlled for each User given a password(s) into the database.

“Hot Link” is a well known term meaning any field or displayed information on a screen which is uniquely presented, such as by being shown in a blue color and underlined. The process of placing the screen cursor over such Hot Link and clicking the left mouse button automatically transfers program control to the related program function.

Broadly, and as disclosed in U.S. patent application Ser. No. 09/925,672, filed Aug. 10, 2001, now U.S. Pat. No. 7,120,935, an embodiment this invention may utilize the global communication network in conjunction with one or more databases to functionally monitor and record the information flow and data relating to an access control system which links Devices (keys, cards, codes, etc.) to Users (keyholders, cardholders, etc.) to Locations (doors, secured lock boxes, buildings, etc.) such that access through each Location is controlled and known. An illustrative system of the present invention can have the ability to maintain current and historical data on each of the three primary components (Devices, Locations, and Users) such that complete history of any component is accessible to an authorized DB-User. Additionally, the system may contain parameter-driven security features which control and limit access to some or all of the data being maintained so as to provide DB-Users with access only to those elements on a “need to know” basis. This system may be characterized in particular by its ability to record and maintain the three primary elements, namely, Devices, Locations, and Users in a real time mode. For example, a DB-User in Rome, Italy confronted with an immediate need to add or replace a key to a given Location in Italy may gain immediate access via the global communication network to the Software located in a distant part of the world, such as, Los Angeles, Calif. to interactively communicate with the Software to establish the DB-User's security level, in this case the authorization to Add or Modify a key, and obtain that key in a matter of hours by way of ordering a new Device for the required Location, assigning that Device to a new or existing Device-User, and directing the Software to issue a Device preparation work order to a nearby Device preparation site (in Rome, Italy, e.g. key cutter).

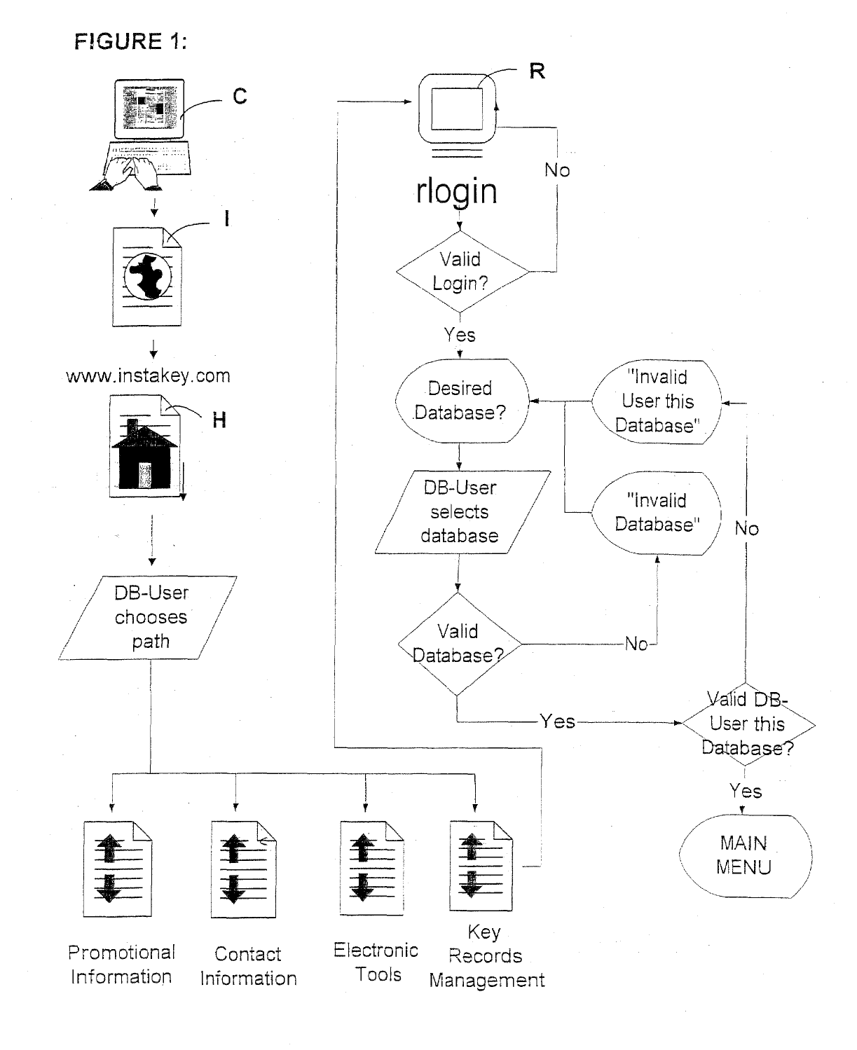

Referring in more detail to the drawings, FIG. 1 illustrates a manner in which an authorized DB-User can access the data and information needed to perform a particular job function. The DB-User employs the Software or computer C to connect to the global communication network or Internet I. From there the DB-User proceeds to the home page and is presented with information about the access control system. Of particular importance is that the DB-User must be positively identified in the system. The exemplary manner of accomplishing this positive identification with the present system is by having the DB User login by a prearranged User name and multi-level password. The prearranged User name and passwords are used as identifiers to ensure that an authorized DB-User can proceed. Assuming that the DB-User is authorized to enter via rlogin R, this DB-User will now be constantly confirmed as to which data, screens, and functions are allowed. Specifically, in the routines outlined, once the login is determined to be valid, the DB-User can access a desired database or level of security and is then able to proceed to the Main Menu.

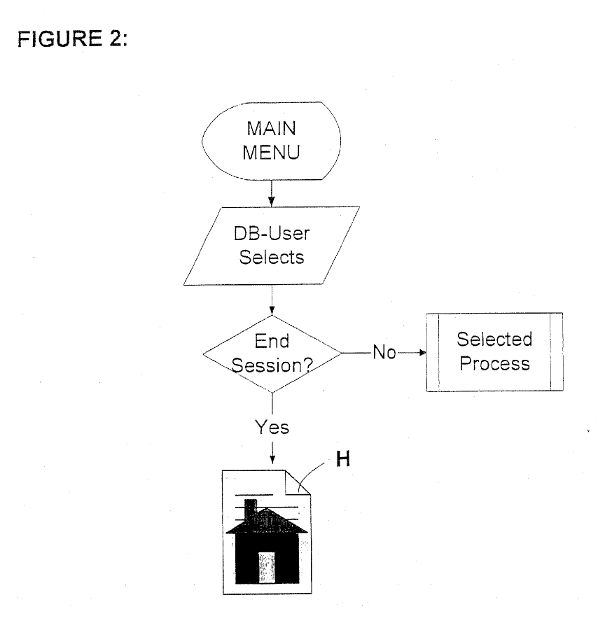

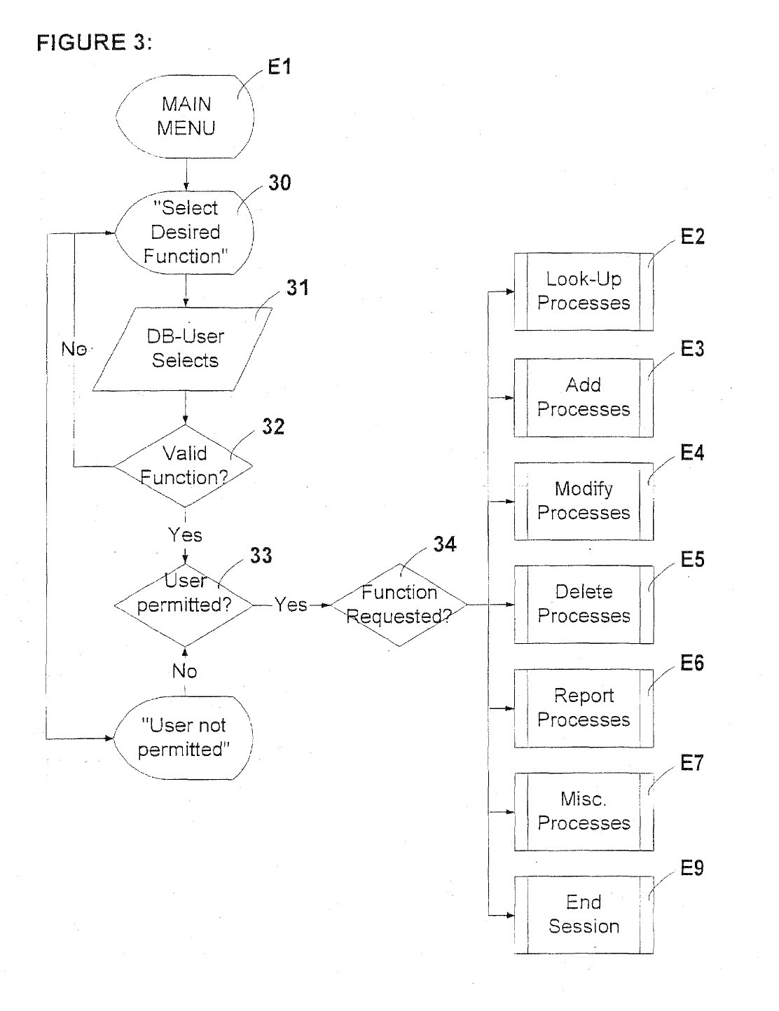

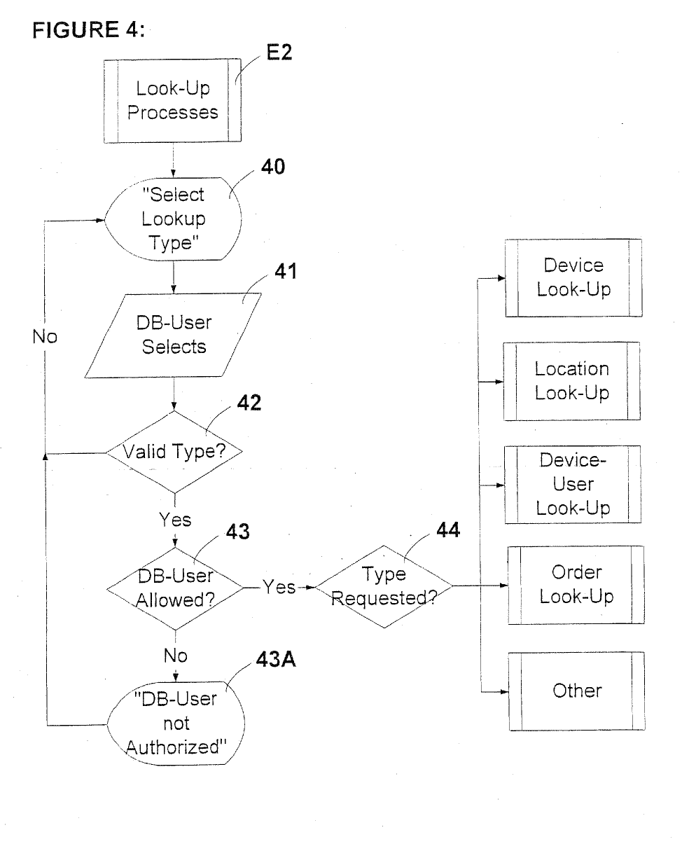

As illustrated in FIG. 2, the DB-User has the option to select a session termination, and, if selected, is logged off and is now back to the home page H illustrated in FIG. 1. Otherwise, if the requested database is valid for the DB-User, he is then presented with the main menu screen at E1 from which it is possible to maneuver to the function to be performed, as illustrated in FIG. 3. The DB-User is asked to select a function as at 30, and the requested function 31 is first verified to be a valid function as at 32. If not, the DB-User is asked to input once again. Once a valid function is input, a security check is processed at 33 to confirm that the DB-User has the privileges granted to ask for the requested function. For example, a security guard may be permitted to look up data about a specific Device-User but is not allowed to manipulate such data. In contrast, a director of security for the entire program may have full privileges to those having access to a particular office even though he does not have privileges to that office. Most importantly, the DB-User has the ability to access controlled data delivered in a real time and controlled venue from any Location in the world and to request a particular function at 34, namely, those designated at E2 through E7 and E9 as more fully shown in FIGS. 4 to 19 and as hereinafter described in more detail.

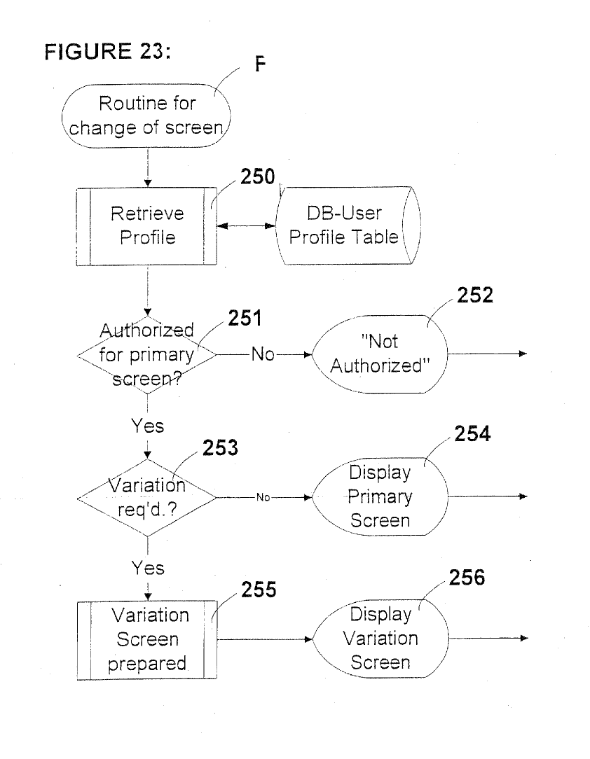

FIG. 23 illustrates a fundamental decision process used throughout the Software to control access to functions and data in exact accordance with preestablished criteria by each authorized DB-User. From wherever this routine has been called as designated at F, the User profile and screen privileges for the current DB-User is retrieved from the Profile Tables at 250. At 251, the Software compares the requested primary screen to the authorization for such primary screen in the tables. If the DB-User is not authorized for this primary screen at 252, a message is displayed accordingly and program logic reverted to the point from which the request was made initially. If authorized, the Software at 253 further determines if a screen Variation is required. If a primary screen is authorized, the primary screen is displayed at 254 and program logic returned to the point from which this routine was invoked. If a screen Variation is required based on the definition in the Security Access Tables, the Variation is formulated at 255, displayed at 256 and program logic returned to the point from which this routine was invoked.

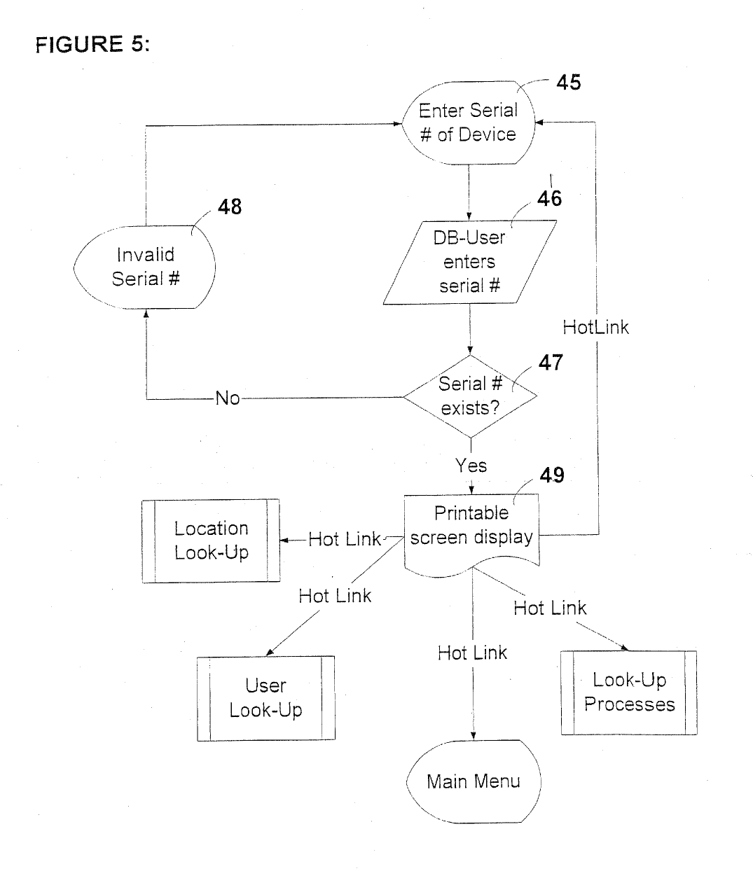

By way of introduction, there are a variety of predefined processes to deliver information on a screen associated with the Software that answers to common access control questions, as typified by FIGS. 4 though 9. FIG. 4 illustrates one branch used to determine the type of look-up the DB-User wishes to pursue and is presented with a menu of different selections or choices as designated at 40. A selection is made and validated at 41 and 42, then confirmed at 43, as shown in FIG. 23, that the DB-User is authorized for a particular request. Thus, for example, a security guard may be authorized to look up a particular Device to confirm ownership, but the same person may not be allowed to view a Location. If the DB-User is not authorized as at 43A, must then reselect at 40; otherwise, if authorized as at 44, may select one of the selections as illustrated in FIGS. 5, 6, 7, 8 or 9 to be described.

In FIG. 5, one example is given in which a key was found and a Database-User must establish its ownership and the door which it operates. Thus, someone with proper authority must look up information about the Device or key found. The Software will request the serial number or other ID of the Device to be entered as at 45 and 46. The key number is validated as a proper number for this database as at 47 or if invalid at 48. If valid, a screen appears as at 49 displaying the designated Device-User, relevant Locations for the Device, date of issue and other information. Other associated data linked to the Device may be hot linked on the screen to make further investigation easy on the part of the DB-User, once the DB-User has been determined to be authorized for such access via FIG. 23. Thus, the screen at 49 can automatically create hot links to listed locations and user if more indepth look-up is desired. The screen at 49 also offers the ability to go back to the main menu or to additional lookups via the hot links as indicated.

The Location Look-Up as indicated at FIG. 5 offers a variety of look-up possibilities by Location, such as, lost key to front door of a Location, need to re-key or burglary committed, need to know who has access; or security director needs to know what Users are involved.

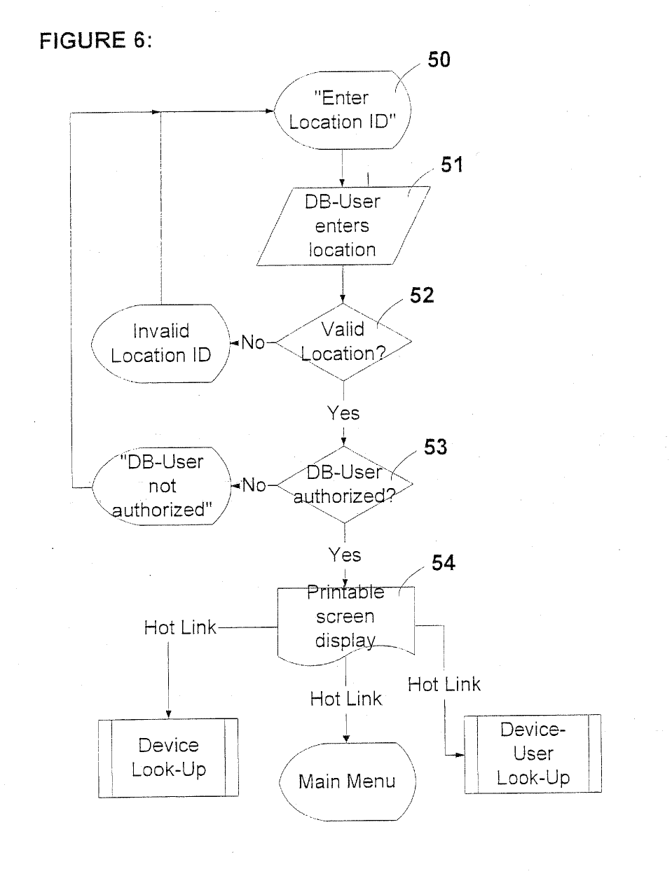

FIG. 6 illustrates a similar scenario for a lost key in which the Location is requested at 50 and entered at 51. A variety of easy enter modes exist include character recognition and pulldown menus when the DB-User enters the Location. If the Location is valid as at 52 and DB-User authorized as at 53, a screen appears indicating Location data. Any associated data linked to the Location or hot linked on the screen as designated at 54, facilitate investigation on the part of the DB-User as further illustrated in more detail in FIG. 6. Again, the screen at 54 creates hot links to listed devices and user if more in-depth look-up is desired on this situation. The screen 54 also offers the ability to go back to the main menu or additional look-ups.

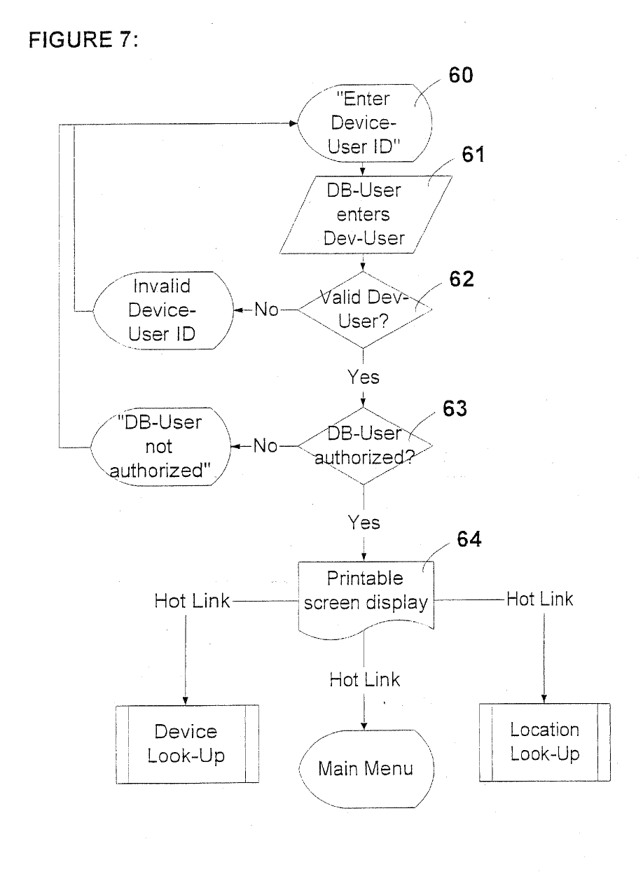

FIG. 7 illustrates a sample process for looking up information about a particular Device-User, for example, if that Device-User should report that a key has been stolen, and need to know all keys currently issued to this User or need to know every key ever held by this User. Thus, the identification of the Device-User in question is entered at 60 together with related information as in 61. If that Device-User is valid as at 62, a determination is made whether the DB-User has proper authority to access the information about the Device-User via FIG. 23 and as designated at 63. If validated, a screen will appear as at 64 indicating Device-User profile and related data for the Device-User claiming to have lost a key. The DB-User making the investigation will be provided with the information needed to make an intelligent security decision as to whether to rekey the Location and if so, how many other Locations may be affected and how many keys will be needed for related Device-Users. For this purpose, the screen automatically creates hot links to listed Devices and Locations if more in-depth look-up is desired. The screen also offers the ability to go back to main menu or additional look-ups.

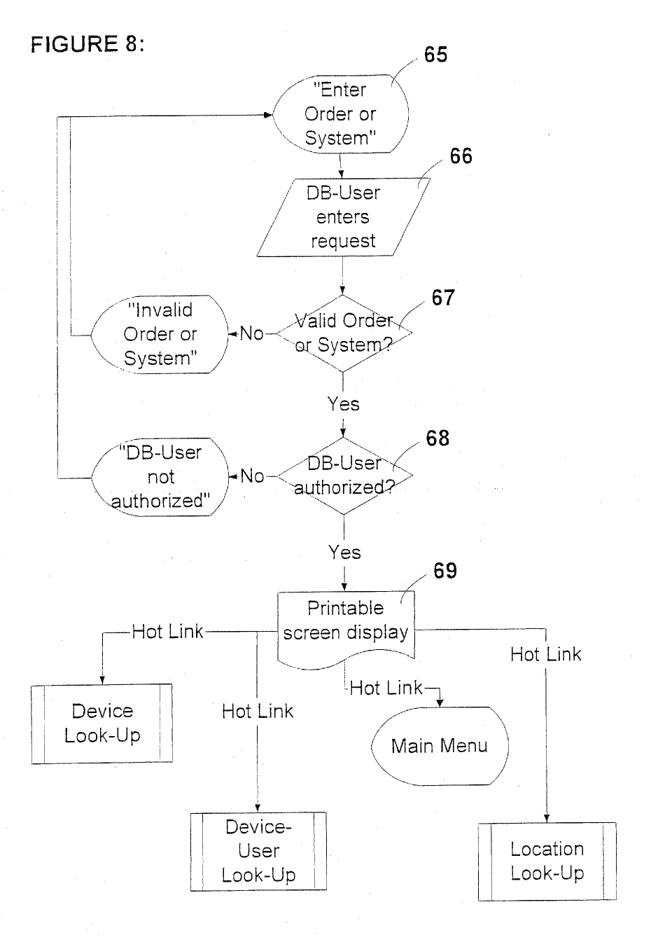

Another look-up process is illustrated in FIG. 8 for viewing overall status of the access control system at 65, such as, current state of master key system in place for different levels, or status of an order placed for new keys to be issued. Thus the DB-User, with proper authorization, may enter a request as at 66, its validity determined at 67, and authorization of User determined at 68. If affirmative, a display will appear at 69 together with standardized hotlinks associated with the displayed information to enable the DB-User to analyze the access control situation.

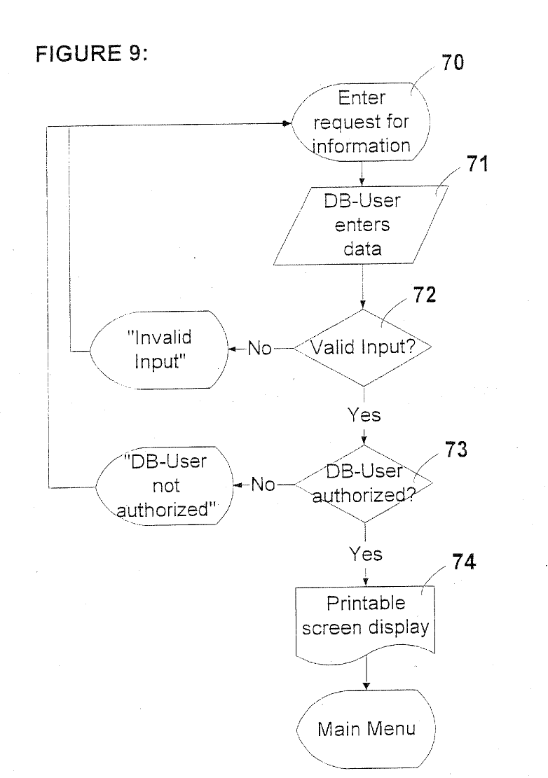

FIG. 9 illustrates other look-up possibilities wherein an input screen is presented at 70 for certain information, the DB-User enters data to be investigated at 71, the data is validated at 72, and authorization determined at 73 leading to display of information requested on the screen 74. The foregoing look-up processes described in relation to FIGS. 4 to 9 are given more for the purpose of illustration and to demonstrate real time data that is available to an authorized DB-User from any Location at any time.

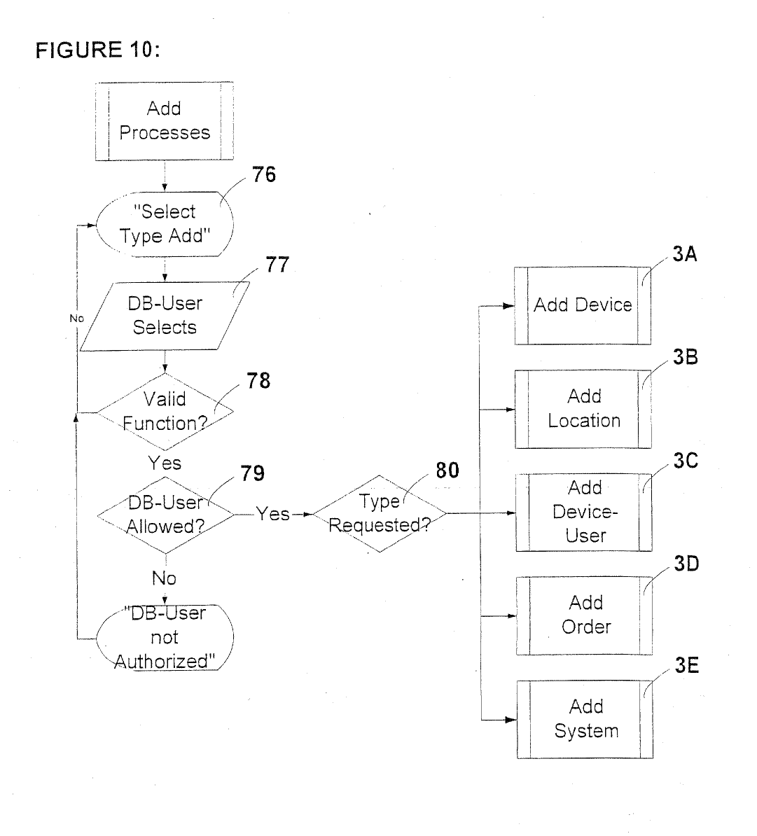

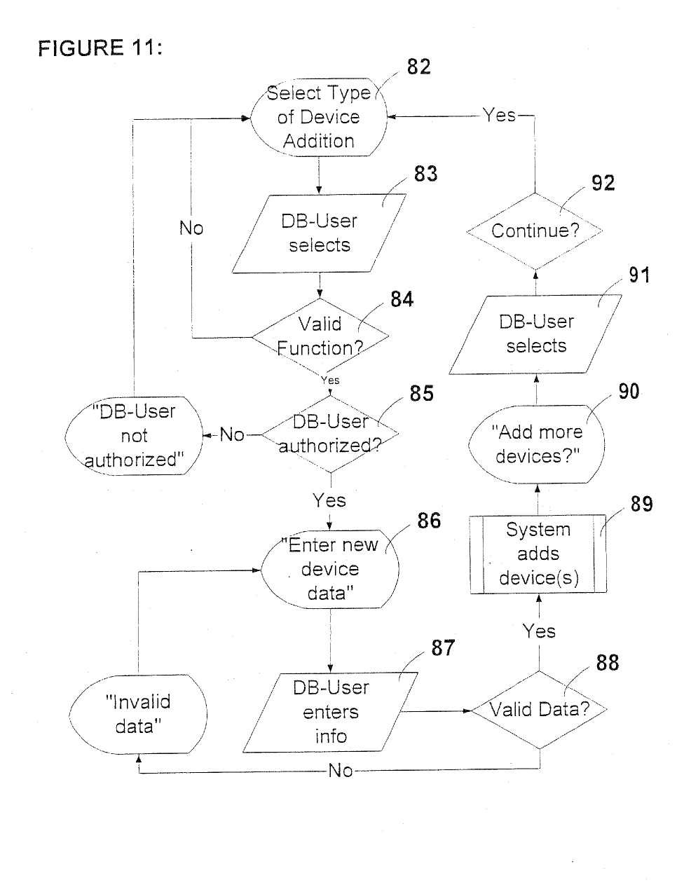

FIG. 10 illustrates the manner in which a new Device (key), Location, or Device-User may be added to a system or new system to a database. Thus, as illustrated at 76, a new Location, order, Device-User or Device is presented for selection by the DB-User, then selected at 77 and valid function determined at 78. Authorization of User is determined at 79 and then the nature of request ascertained at 80 from several different possibilities as designated at 3A, 3B, 3C, 3D and 3E as further illustrated in more detail in FIGS. 11 to 15.

In the example given in FIG. 11, the addition of a key blank (an uncut key or unprepared/encoded Device) is recorded by first presenting a menu of Device types for addition at 82, selecting the type of blank to add at 83, verifying that it is a valid function at 84, and that the User is authorized to perform the function at 85. Proper verification results in a blank data entry screen 86 whereby the User enters all relevant data at 87 and the system performs appropriate editing at 88. Once complete, the Software records the entry as at 89 and then inquires whether more such entries are desired or not via 90, 91, and 92.

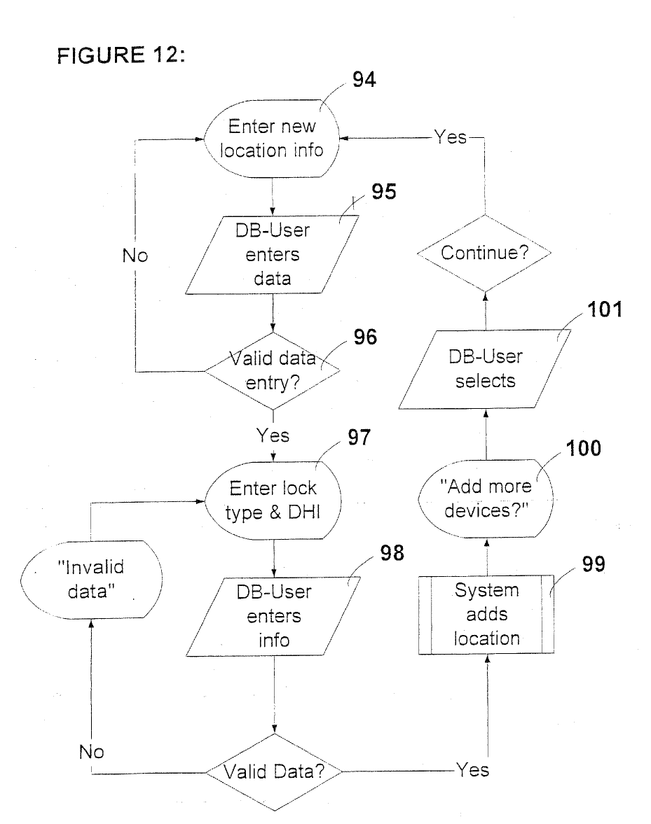

The process of adding a Location into a particular database is illustrated in FIG. 12 wherein the DB-User enters a new Location at 94 and appropriate data relating to that Location at 95. The data is verified at 96 and then as a response authorized as a DB-User via FIG. 23. Proper verification results in a blank data entry screen 97 and the DB-User enters relevant information at 98, the Software editing in accordance with established database parameters. Once complete, the Software records the entry at 99 and asks the User if more keys or Devices are to be entered as designated in 100, and a selection is made at 101.

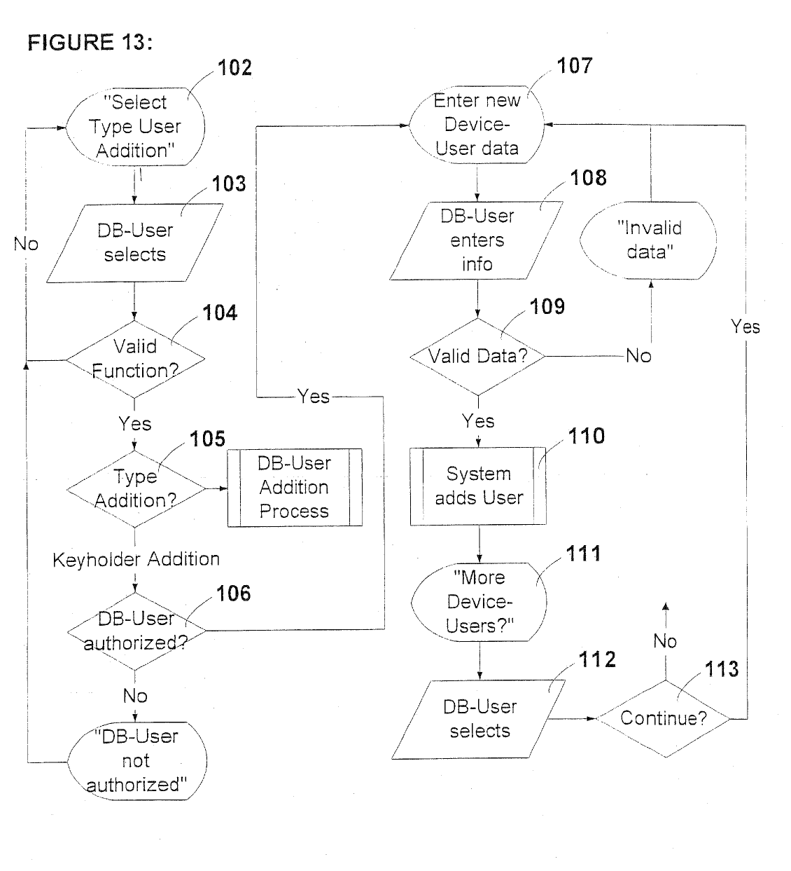

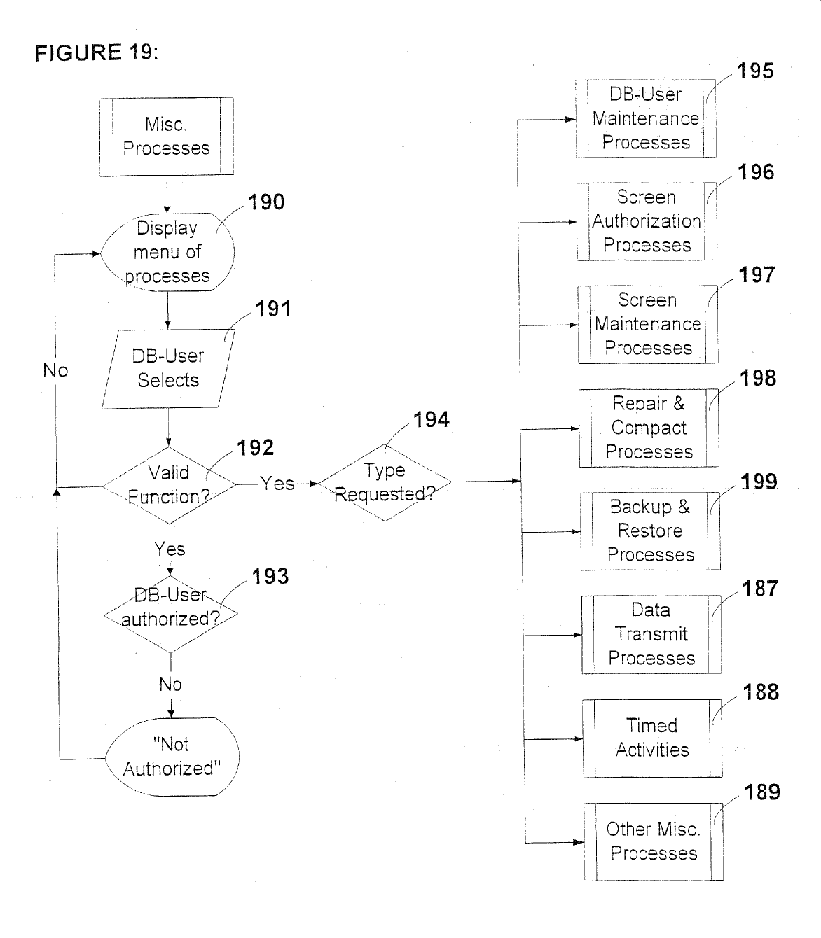

A process similar to that of FIG. 12 is illustrated in FIG. 13 for adding a User at a particular level of security to an existing Location. An authorized DB-User is asked for the type of User to add at 102 and a response is entered at 103. The Software verifies that the function is valid at 104 and determines the type of User addition at 105. If the type of User being added is a new DB-User, Software transfers accordingly (FIG. 19). Otherwise, authorization of the DB-User to add a new Device-User is confirmed at 106. If so authorized, the new Device-User data entry screen is presented at 107, and the DB-User enters all other relevant data at 108 which is verified at 109 and, if accurate and complete, is recorded at 110 in the database. The DB-User is then asked if more Device-Users are to be entered at 111, the DB-User responds at 112 and a decision to add more made at 113 in which event the DB-User is either returned to the data entry routines for new Device-Users at 107 or other available software entry points as selected by the DB-User.

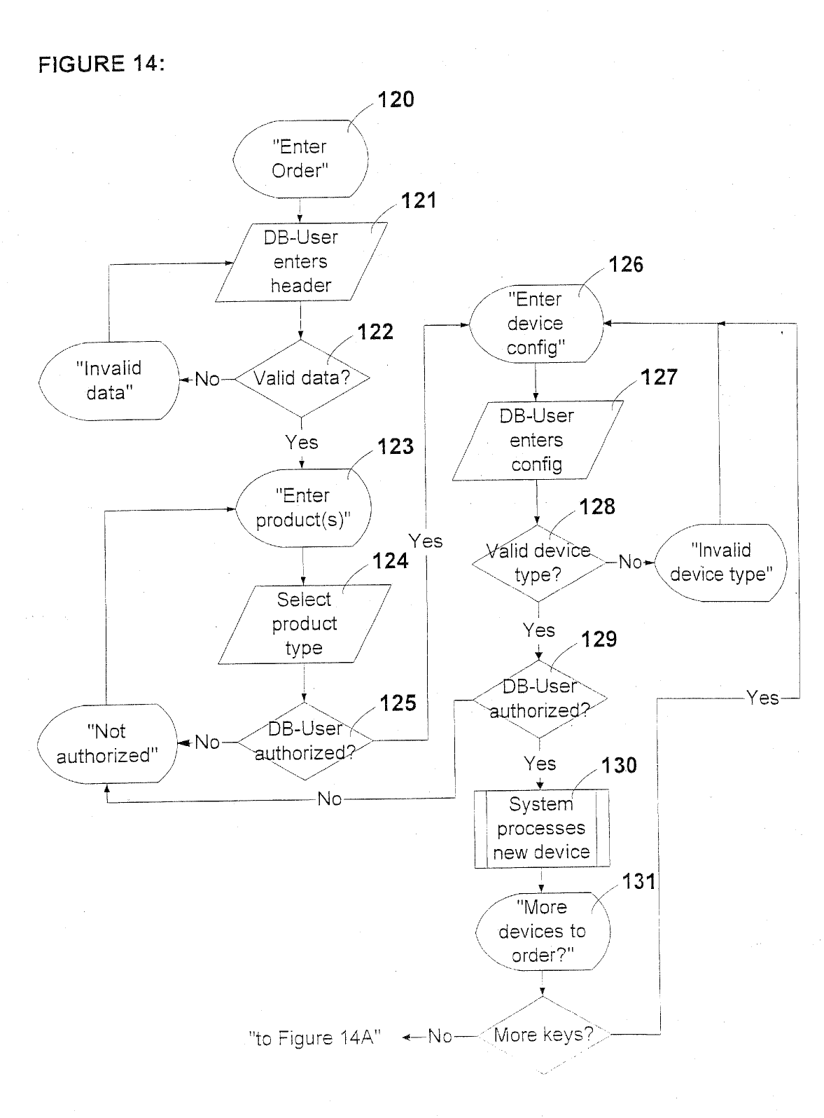

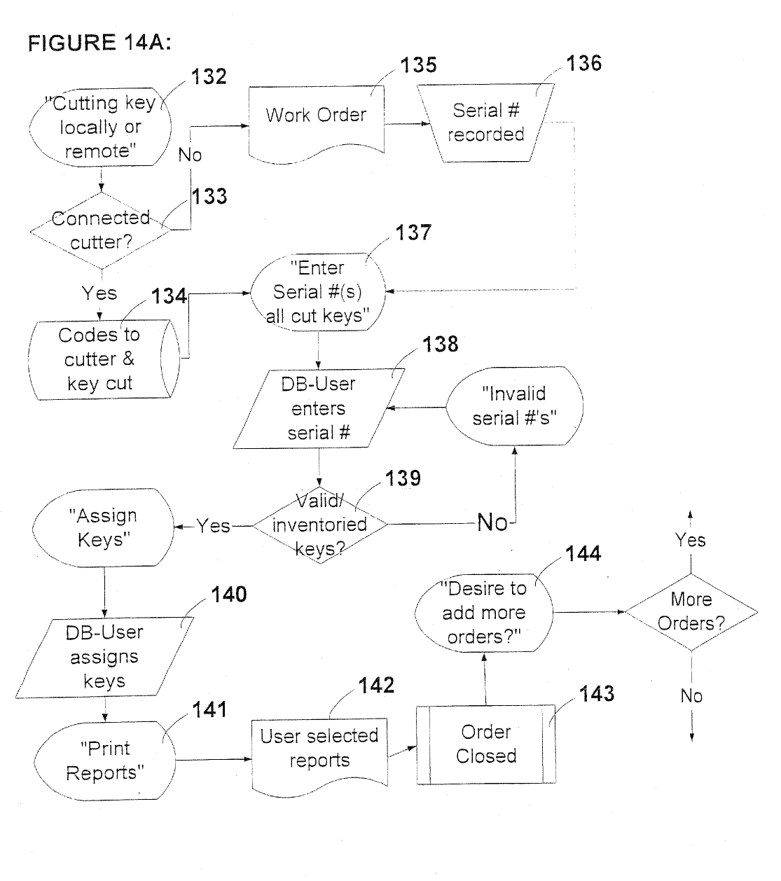

The process of placing an order, for example, a new key for a new Device-User to allow that Device-User access to a specific Location, is illustrated in FIG. 14 wherein the DB-User is presented with a blank order header entry screen at 120. The DB-User enters the appropriate data on the screen as at 121, the Software editing in accordance with established parameters at 122. If all data entry is valid a screen is presented offering choices of product to be ordered at 123 wherein the DB-User makes his selection at 124 and is confirmed for ordering authorization (FIG. 23) at 125. Validated authorization to order a key results in a blank entry screen at 126 by which the DB-User requests the exact key needed in submitting the request at 127, the Software validating the type of key being requested at 128 and that the DB-User has authority to order this type of key at 129. Complete validation results in the Software recording the order at 130, a request to the DB-User if more keys are required at 131 and a decision based on response to repeat the key request portion at 126 or move on to the processing of the order at 132 (FIG. 14A). The DB-User is asked at 132 if he intends to cut the ordered key(s) at a local key cutting machine or transmit a work order digitally to a remote Location wherein a decision is made at 133 to send appropriate codes directly to the key cutting machine at 134 or transmit the order to a remote facility at 135 whereupon cutting of the keys, serial numbers of the blanks used are recorded on the work order at 136. Following completion of the key cutting, the DB-User is required to enter the serial numbers of the blanks from which the key was cut via the input screen at 137, the DB-User enters such serial numbers at 138, and the Software validates that such serial numbers exist for this database at 139. The Software then requires the DB-User to assign such keys to a particular Device-User at 140 and allows the DB-User to then print any relevant reports needed at 141 and 142. The order is then closed at 143 and the DB-User asked if there are more orders to process or not at 144.

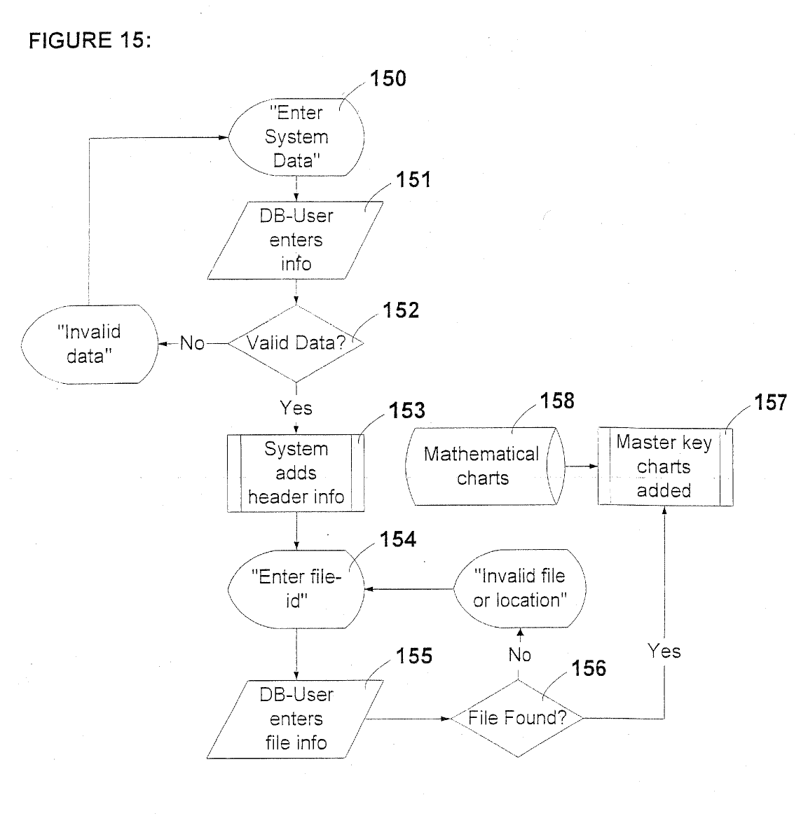

FIG. 15 illustrates the manner in which a new system may be added to the database, such as, master key charts for a secondary campus to be added into the security system. Thus, as illustrated, the DB-User is asked to name the incoming system and system header information at 150 and 151. The Software checks for duplicate system names data integrity in accordance with established criteria at 152 appropriately recording system header information in the database at 153. The DB-User is then asked to direct the Software to the Location of the data files (previously generated using a different software program) being imported at 154 and 155 whereby the Software then locates the file at 156 and imports the data from a source of mathematical charts 158 into the database at 157.

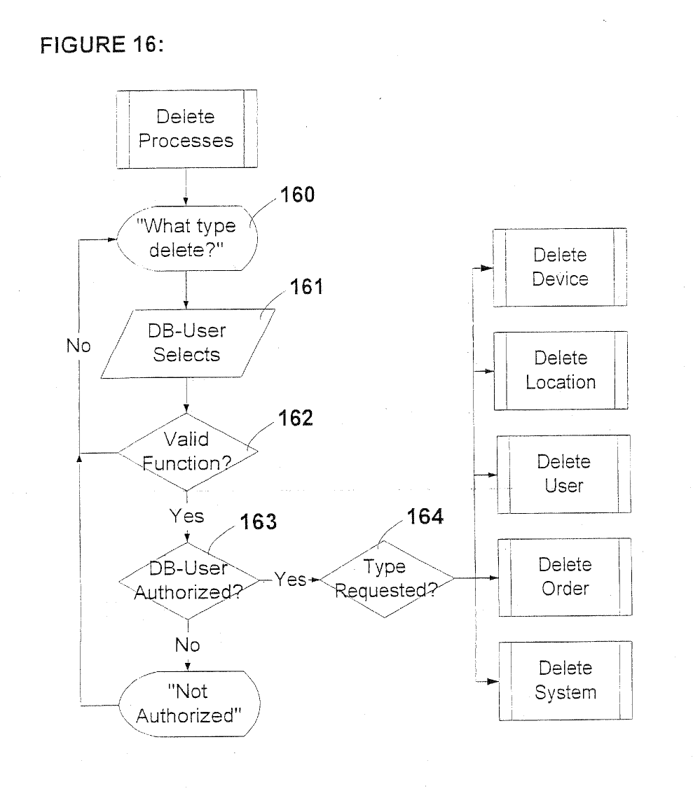

FIG. 16 illustrates the manner in which a selected Device, Device-User, or Location may be deleted from the database. Thus, as illustrated, a screen is presented of delete types at 160, the DB-User selects the type of deletion desired at 161, the Software confirms the type of deletion at 162, verifies authorization for the requested deletion at 163 (FIG. 23) transferring program logic at 164 to the requested and programmed routine. Said routines are quite similar to various described “Add” routines and therefore are not presented as figures herein.

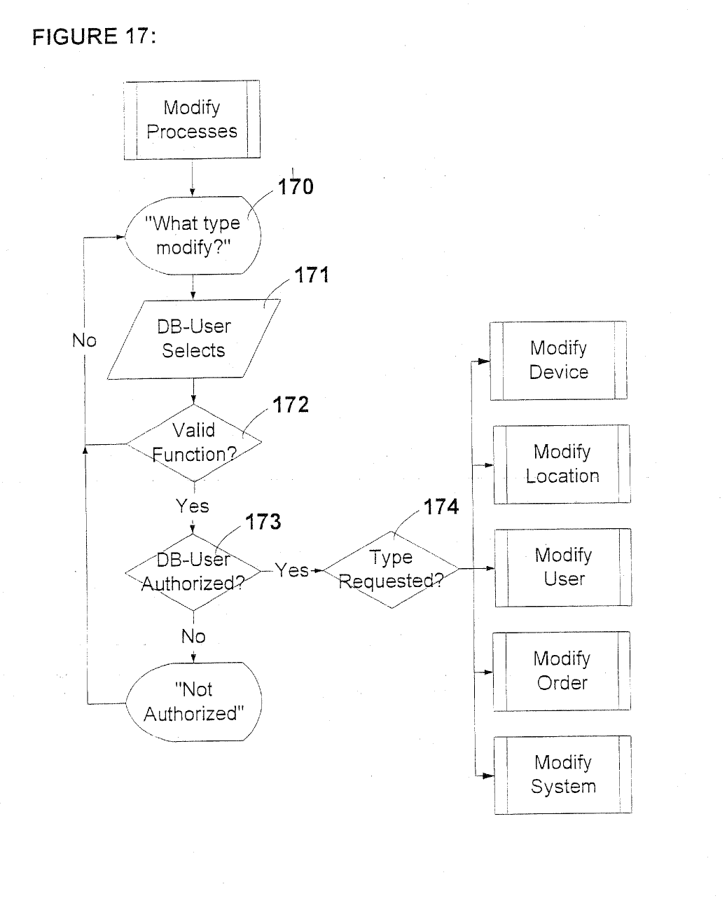

FIG. 17 illustrates the manner in which a selected Device, Device-User, or Location may be modified from its current form in the database. A screen is presented of modify types at 170, the DB-User selects the type of modification desired at 171, the Software confirms the type of modification at 172, verifies authorization for the requested modification at 173 (FIG. 23) transferring program logic at 174 to the requested and programmed routine. Said routines being quite similar to various described “Add” and “Delete” routines, such individual routines have not been presented as figures herein.

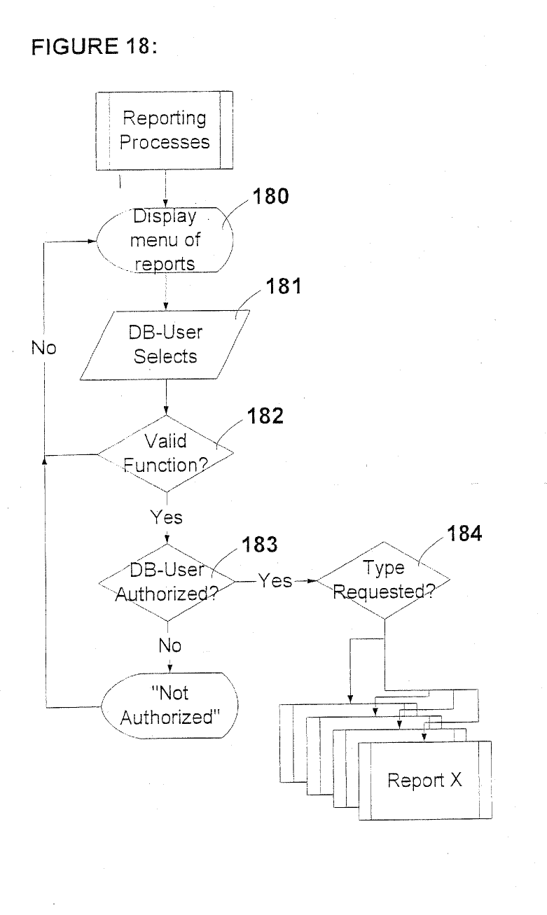

FIG. 18 illustrates the manner in which the DB-User selects a desired report from a variety of preprogrammed reports at 180 and 181, wherein the Software validates the request at 182, confirms authorization of the DB-User for the requested report at 183 (FIG. 23) and generates the requested report at 184. Sample reports include all open orders or order status reports; all active keys used for auditing purposes; work orders, such as, cylinder pinning, device configuration; historical reports, such as, User, Device, Location; Device, Location, User labels; system status reports; key/Device receipt; various packaging formats, such as, step packets, post card transmittals; and various usage and comparative graphs, etc.

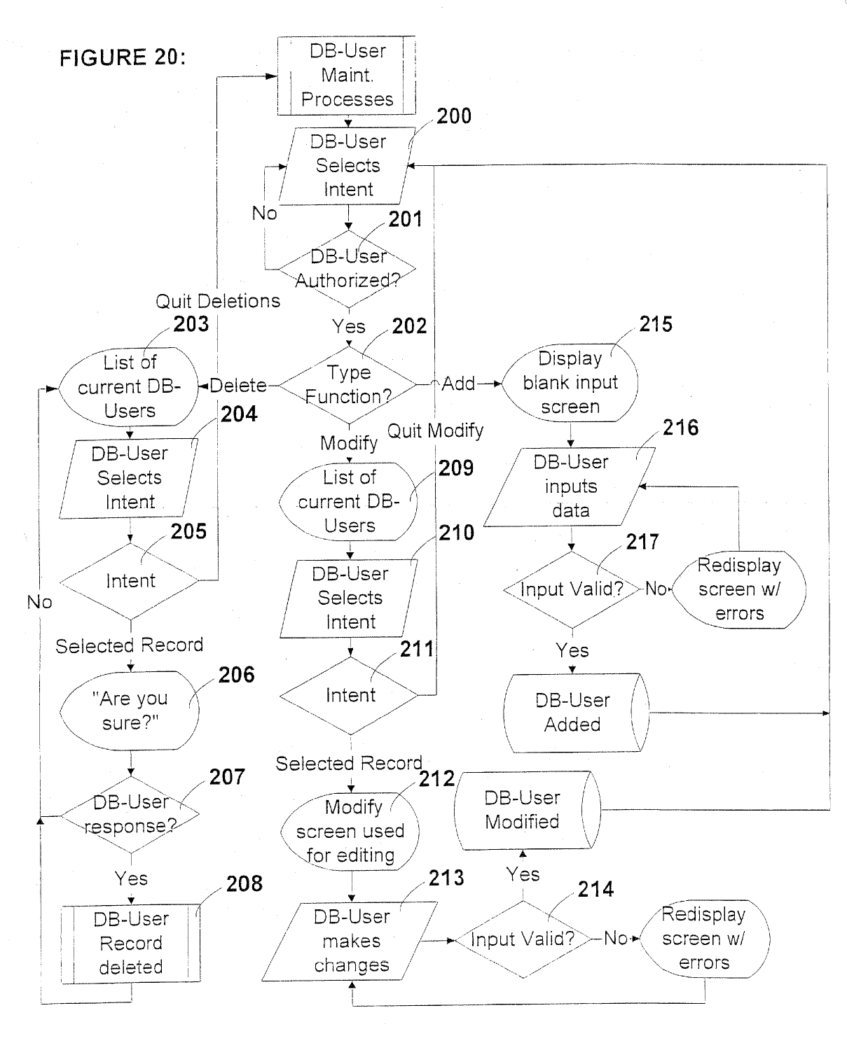

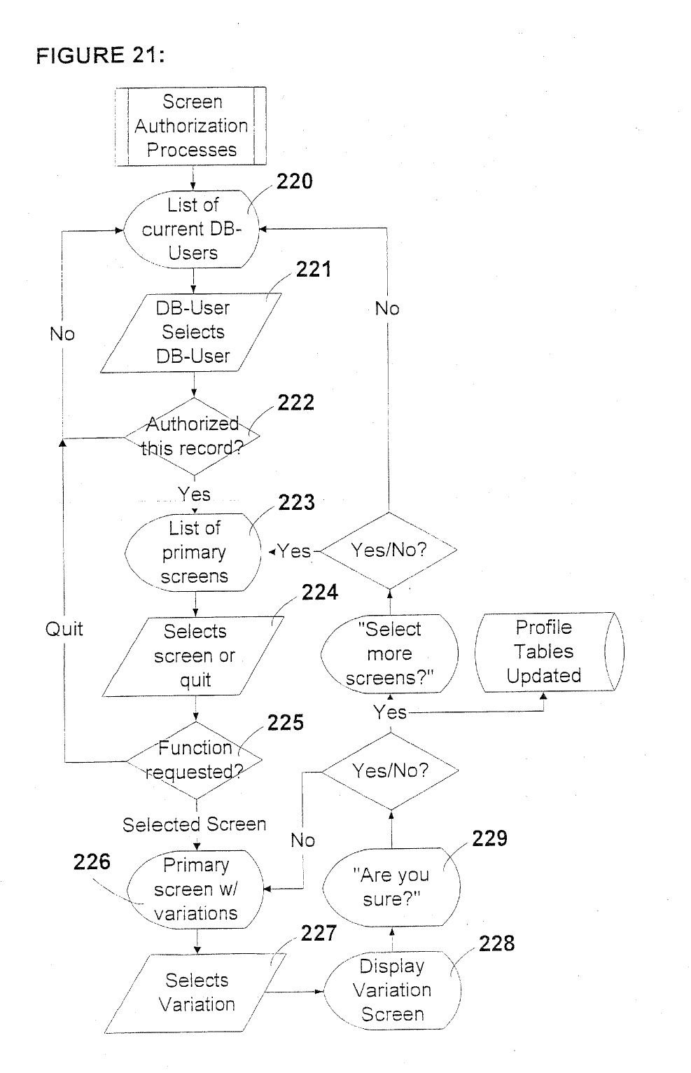

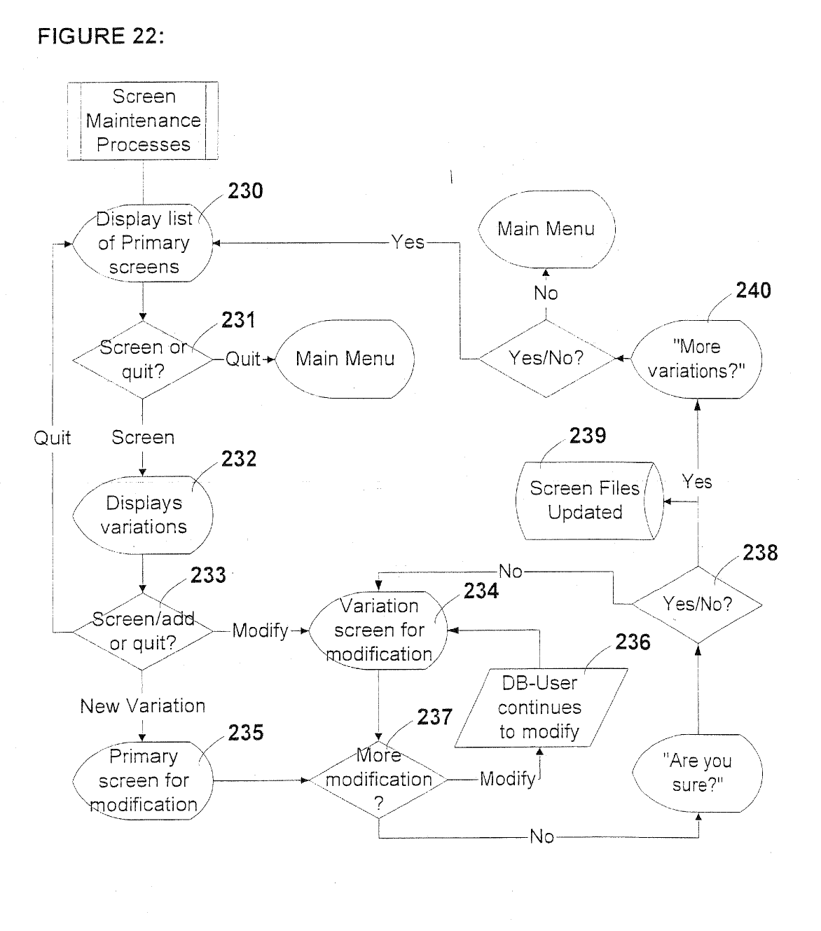

FIGS. 19 through 23 illustrate the specialized routines used within the Software to fully control access to the stored data by each individual DB-User as well as perform various database related utilities. FIG. 19 illustrates the manner in which the DB-User selects a desired miscellaneous process of programmed processes at 190 and 191, wherein the Software validates the request at 192, confirms authorization of the DB-User for the requested process at 193 (FIG. 23) and transfers program logic to the requested and authorized process at 194. Sample processes include: DB-User Maintenance at 195, the process by which a DB-User is actually identified and structured as an authorized DB-User as shown in FIG. 20; screen authorization at 196, the process by which a DB-User is assigned various screen privileges such as add, modify, view, delete as in FIG. 21; screen maintenance at 197, the process by which screen displays are physically configured to meet the authorization requirements of a particular DB-User as in FIG. 22; various database maintenance routines as indicated at 198 and 199 and other preprogrammed processes not directly tied to the maintenance and control of the key management program (Devices, Locations and Users) as designated at 187, 188 and 189.

A real time activity reporting function of the present invention may be implemented into the flowchart shown in FIG. 19 as a process which is performed by the Software upon validation of the function at 192. As discussed above, the process would include retrieving one or more types of data on Locations, Devices, and/or DB Users showing activity within a selected time period, and displaying that information in a report.

FIG. 20 illustrates the process by which an authorized DB-User adds, modifies or deletes other DB-User profiles in the Security Tables of FIG. 24. The DB-User is presented with a menu of options at 200 with authorization confirmed at 201 and functionally transferred at 202 to the appropriate routine (“Add”, “Modify”, Delete”). If the authorized DB-User selected “Delete”, he is presented at 203 with a list of all recorded DB-Users whereby he selects the appropriate record for deletion or quits the deletion process at 204. If the selection is that of a record at 205, the DB-User is then asked “Are you sure?” at 206, with an affirmative response at 207 resulting in the selected DB-User record being deleted from the Profile Table at 208 and program control shifted back to the list of DB-Users at 203. If the authorized DB-User selected “Modify”, he is presented at 209 with a list of all recorded DB-Users whereby he selects the appropriate record for modification or quits the modification process at 210 with appropriate program transfer occurring at 211. If a record was selected for modification, the DB-User is presented with an entry screen bearing all currently recorded data for the selected DB-User at 212 whereby the DB-User makes required changes at 213, the system verifies data integrity at 214 properly recording the modification if all is accurate or returning appropriate error messages if not. If the authorized DB-User opted to add a new DB-User at 200, the Software presents an empty profile entry screen at 215 whereby the DB-User would enter relevant data at 216 and such data validated at 217, properly recording the addition if all is accurate or returning appropriate errors messages if not.

FIG. 21 illustrates the program logic used by which the authorized DB-User configures the Software to present certain screens and certain Variations of screens for the selected DB-User. At 220, the DB-User is presented a list of all DB-Users from which to select the DB-User at 221 for which changes are to be made. The system then confirms the authority of the DB-User relative to the selected DB-User at 222, presenting then a list of primary screens available at 223 if so authorized. The DB-User then selects a screen or quit at 224 whereby the system transfers accordingly at 225. If the DB-User selected a primary screen, the system then displays a list of prepared variations to this primary screen at which point the DB-User selects the desired variation at 227, a sample variation screen is displayed at 228 along with a confirmation message at 229. Depending upon confirmation or not, programmed functions then modify the DB-User record accordingly or transfer program logic to continuation or termination of these screen authorization routines.

Referring to FIG. 24, DB-User 1 typically is a Manager or Security Director of the User company who is programmed to be able to use all three Primary screens meaning he can see all (data) and do (view, modify, add, delete) everything. DB-User 2 typically may be an assistant to a Manager who is programmed to perform any function on Primary Screen 1 but can only use Primary Screen 2 as Variation 1, Variation 1 having been previously defined by field as to what the individual can see (data) and do (view, add, modify, delete) by field.

FIG. 22 illustrates the process flow by which a managing DB-User can create customized Variations of Primary Screens such that a specific DB-User can only see or do exactly what the managing DB-User authorizes another DB-User to see and do. At 230, the managing DB-User is presented with a list of all Primary Screens of which those Primary Screens with already established Variations have been highlighted to inform the DB-User that Variations of that Primary Screen are already available. The managing DB-User selects the Primary Screen from which he wishes to concentrate at 231, subsequently selecting to modify an existing Variation from a drop down list of Variations in 232 or to create a new Variation. At 233, the Software determines based upon the DB-User selection to present the selected Variation for modification at 234 or the selected Primary Screen for creation of a totally new Variation at 235. At 234 or 235, the managing DB-User is allowed to alter each field of the selected screen Variation in order to describe Add, Modify, View or Delete privileges, by field as well as define data delimiters (e.g. only data for a specific department). Upon completion of the field-by-field modifications, the managing DB-User views a current version from which to determine if more modifications are required or not at 237 with confirmation at 238, at which point, the screen is permanently recorded in the screens file at 239 and the managing DB-User presented with the option to do more screen variations or not at 240.

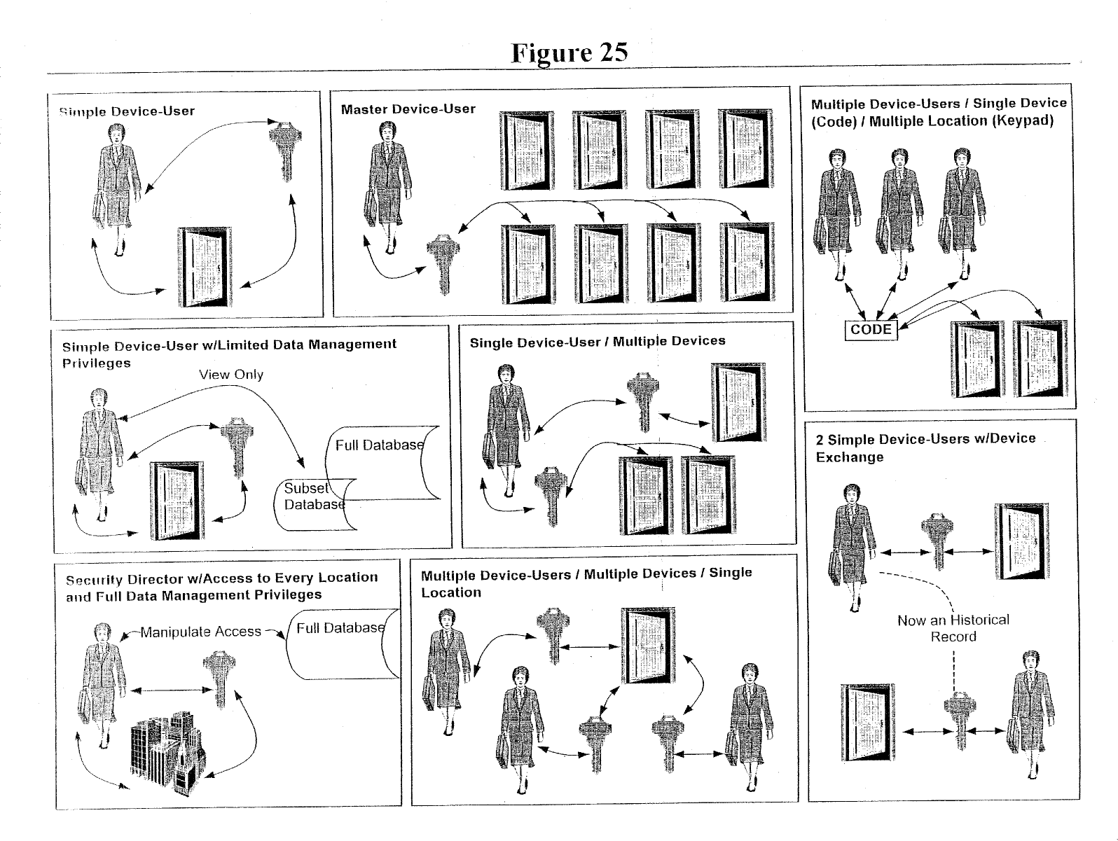

Referring back to the definition of Device-User, FIG. 25 graphically depicts different typical Device-User situations but is not intended to be limiting on the number of applications possible for Device-Users. In a corresponding manner to that described with respect to FIG. 24, it is possible to control the level of access of each Device-User to one or more secured Locations based on the password assigned to that Device-User. The Device-User also may be given additional privileges corresponding to those of the DB-User according to the password assigned. From the foregoing, there has been set forth and described an internet-based access control system that dynamically links the three primary elements of any access control system, namely, people, places and devices used to allow access in such a way as to deliver need-to-know information to any authorized individual from any authorized internet access point. Thus, it is possible to manage access controlled data by way of the internet in a real time mode.

In the Example previously given on page 14 of a DB-User in Rome, Italy confronted with an immediate need to add or replace a key to a given location in Rome, the User may gain immediate access via the global communication network to the data needed in another remote location, such as, Los Angeles, Calif., with respect to the new key. Upon proper authorization of the logged-in, Rome-based DB-User, a key (Device) can be ordered immediately and the details needed to prepare the device can be routed to the Device preparation facility nearest to Rome. That facility configures the Device, immediately recording the activity along with all configuration parameters and sends the Device to Rome. Upon receipt, Rome hands the newly created Device to a Device-User and records the activity. Throughout the entire Example, every individual with authorized privileges has access to the information as it occurred, namely, that a new key was ordered in Rome at a given hour of a given day, that a Device was prepared, recorded and shipped to Rome, whereupon receipt of the new Device, was handed to the person authorized to receive it. Thus “real time” means the actual digitized activity as it occurs being made available to whomever is authorized to view such data from wherever that DB-User may be located while maintaining a single database of information.

A system and method is further provided for DB Users to monitor activities occurring in a system such as, for example, disclosed in the '672 application, on a real time basis. That is, for example, a DB User may choose a period of time and view a report on any activity represented by stored information or data associated with, for example, a given Location, group of Locations, or an entire operation (which may, for example, be a corporation with a number of different Locations, such as divisions, plants or stores).

As additional examples, a retail operation may have a large number of Locations, such as individual stores, which are undergoing either rekeying or new lock installations. A real time activity report related to such an operation would enable a DB User to select a desired time period and report data (according to a DB User's authorized access level to the system) associated with that time period. This data may, for example, report on an entire organizational operation, such as by reporting how many Locations have been rekeyed to date (or during another selected time period) or installed with new access control Devices to date (or during another selected time period) versus how many Locations have yet to be rekeyed or to have new Devices installed. To enable this type of activity reporting, Software of the system enables the DB User to search the database for the desired data, such as all orders fulfilled within a selected time period. The software formats the data into a report which is displayed to the DB User. Any activity or information which has been stored in the database in an appropriately categorized or formatted manner may then be quickly searched for activity within a selected time period and then displayed or reported in any desired manner to the DB User. Generally, such data may relate to the operation and/or security of one or more Locations, or to the general management or financial impact of activities represented in stored data involving Device-Users and/or DB Users, and/or Devices and/or Locations during the selected time period.

In particular, the real time activity reporting function of the present invention may be implemented into the flowchart shown in FIG. 19 as a process which is performed by the Software upon validation of the function at 192. As discussed above, the process would include retrieving one or more types of data on Locations, and/or Devices, and/or Device-Users, and/or DB Users showing activity within a selected time period, and displaying that information in a report. The activity or information may include any time dependent data that is entered into the database(s) as, for example, described herein.

### Order Submission and Approval

In another embodiment, the order submission and approval process may be modified to achieve certain benefits. This order submission and approval process may, for example, be implemented in a routine which is similar to the routine shown and described in connection with FIGS. 14 and 14A herein, as modified to include the options and enhancements described below.

In certain instances it may be desirable to establish a hierarchy of DB-Users and delegate authorities and responsibilities accordingly throughout that hierarchy. In this type of system, the Software would be designed to delegate certain levels of authority to, for example, lower level employees, managers, supervisors or other positions in an organization, and to delegate higher levels of authority and responsibility to one or more persons at a higher level of management or supervision in the organization. For example, in a college or university setting where there may be 50,000 active keys in a dormitory system, each of those active keys may be represented in one or more databases of the system as a Device. The administration of the university or college may elect to delegate daily management of keys operable in a particular dormitory to the resident hall manager of that dormitory. The resident hall manager would be set up as a DB-User, as described herein, with Software privileges related only to that dormitory (i.e., that Location) in accordance with previously described features of the present system, and be given authority to order keys as necessary for that dormitory and its key holder (i.e., Device User) population.

In this type of setting, however, the university or college administration might desire to ensure that certain policies set forth for the entire campus be maintained and monitored. For example, it may be acceptable to allow the resident hall manager to order individual dormitory room keys as needed, as long as the whereabouts and other desired information concerning those keys are maintained in the system. However, the university or college administration may desire to require that the ordering of a master key to the entire dormitory be approved by some higher level of authority at the university or college than the resident hall manager before that order is allowed to continue further in the ordering process and ultimately be submitted for procurement. Thus, this embodiment provides the system with a defined chain of command that may also automatically move an order through that chain of command while ensuring that orders do not become lost or forgotten in the system. The various features of this embodiment, which may be used singly or in any appropriate combination as with the other features described hereinabove, are described further below.

### DB-User Authority Definition

According to this feature, the Software is designed to allow specific Device ordering privileges for each DB-User to be defined during a setup mode. During this setup mode, an administrative screen will be used to allow the system to be configured as to what the chain of command (i.e., the chain of approval) must be in the event that an order is placed for a Device by the DB-User whose order privileges are being set up. Using this routine, the DB-User's privileges are automatically set and saved in the system, including approval routing through one or more authority or management levels above that DB-User. Using this setup routine, the Device ordering privileges for the DB-User may also be configured relative to the actual rights being delegated, such as what Device or Devices are allowed to be ordered and/or submitted for procurement by that DB-User, and what other Devices are not allowed to be ordered or submitted for procurement, or may be ordered but must be approved by some higher level of authority or management before being submitted for procurement. This setup routine may also determine what types of Devices may be ordered, how many Devices may be ordered, etc. The setup routine may allow any other order related parameters to be established for each DB-User, as necessary for a given application of the system. Appropriate subroutines may be integrated into the steps shown in FIGS. 14-14A to implement the approval process.

### Automatic Order Routing

Once a DB-User completes their order and is ready to submit it for procurement, the Software automatically references the privileges such as defined in the DB-User setup routine described immediately above and informs the ordering DB-User as to whether the desired order is now going directly to procurement or first on to an “approver.” As described above, the approver may typically be a person in a higher level of authority or management or perhaps a person specifically handling security in the organization. If the order is moving directly on to procurement according to that DB-User's setup information, then the order is no different than the Software as previously described in reference to FIGS. 14 and 14A, for example. For example, that order may then be filled by production, closed by production, and the Device ultimately delivered to the ordering DB-User or to another person, for example, designated by the DB-User or otherwise. On the other hand, if the order requires one or more higher levels of approval, the system will display a “submit for approval” button or icon rather than a “submit for production” or “submit for procurement” button or icon, for example. This may be implemented within step 125 and/or 129, for example, shown in FIG. 14. The order will then be submitted to an approver or approvers. Multiple approvers may be utilized successively or jointly depending on the needs of the system. After the final approver has approved the order, the order is then submitted for procurement (e.g., production). The submittal to procurement may take place automatically by the system or, for example, a prompt to the ordering DB-User may be generated allowing that DB-User to submit the order via a pre-established procedure in the system, such as previously described herein.

### Constant Reminder Feature

To ensure that the order does ultimately get to production or other procurement, the system may be configured to closely monitor that order to ensure that it is ultimately either approved or disapproved and thereby completed. Thus, to ensure that orders awaiting approval do not remain in queue for lengthy periods of time awaiting approval, the Software is configured to constantly remind each approver, who may be DB-User in the prescribed chain of command, by constantly reminding that approver/DB-User with a list of those orders awaiting approval each time that approver/DB-User logs into the Software, and/or at other selected time intervals.

### Real Time Status of Orders

The system may also be configured such that any participant in the Device order chain (e.g., the DB-User who initiated the order, and/or the DB-User who approved or is in the process of approving the order, and/or the production facility that will produce the order, etc.) can display the routing and timing of that routing by viewing an order header on a computer display. This allows all DB-Users that have the authority to use the Software to determine the status of a particular Device order. For example, the system may store and display orders by particular order numbers and when a DB-User with proper authority selects or “clicks on” that order, a display shows when the order was submitted for approval, when the order was actually approved by any and all approvers in the chain of command or approval, and when the order was submitted for production or other procurement. Of course, additional or alternative order information may be stored and displayed as appropriate for the particular application of the system.

### Infinite Chain of Approvers

The system may be designed such that the levels of approval for any given order that are possible in the system are finite or infinite. For example, if it is known that a particular application for the system will never require more than 10 levels of approval, the Software may be configured to allow each DB-User to be set up for a maximum number of 10 levels of approval. Each level of approval could also have one approver or multiple approvers. However, in many situations and for more universal application of the Software, it may be desirable to allow for as many levels of approval, and as many approvers, as might be necessary. Therefore, this feature provides no maximum for the number of approvers associated with and required for a given DB-User to place and submit Device orders for production or other procurement.

### Regular Monitoring and Exceptions Reporting

The system may include a feature that allows an authorized DB-User to see activity reported in various statistical scenarios. For example, a report may be generated to show how many orders were placed during a particular time period in total, by Location, for particular Device-Users or by particular Database-Users, etc. Other reports may be generated to show the average length of time necessary to move an order from one stage of the process to another stage of the process, such as from initial order submission for approval to order production or other procurement. Another report may be generated to show the average length of time that it takes a particular DB-User to process his or her part of the procedure, such as the time it takes any given approver to actually approve or disapprove of orders submitted to his or her attention for approval. It will be appreciated that many different types of data may be available in the system, stored in one or more databases, for example, such that many different statistical or other types of reports may be generated in accordance with the needs of the particular application of the system.

As employed herein, the term “global communications network” may refer to intranet as well as internet usage.

While the present invention has been illustrated by a description of various embodiments and while these embodiments have been described in some detail, it is not the intention of the Applicant to restrict or in any way limit the scope of the appended claims to such detail. Additional advantages and modifications will readily appear to those skilled in the art. The various features of the invention may be used alone or in any combinations depending on the needs and preferences of the user. What is claimed is:

1. An interactive system for security management, the system accessible via a communications network by a plurality of DB-Users and adapted to manage a security system associated with places physically protected by corresponding security components used to control physical entry to the places, the system comprising:
at least one searchable database configured to store information on the DB-Users and the security components, and
Software configured to recognize different profiles established based on the information for different DB-Users wherein each profile defines an authority level of the corresponding DB-User including, for at least one of the DB-Users, the requirement for at least one approver in addition to said one DB-User necessary for submitting an order for one or more of the components of the security system.

2. The system of claim 1, wherein the Software is configured to direct the order through a plurality of separate approvers of the order.

3. The system of claim 2, wherein the approvers are in a hierarchy such that a first one of the approvers must approve the order before the order is forwarded on to a second one of the approvers.

4. The system of claim 1, wherein the at least one searchable database stores information defining which Devices may be ordered by each of the plurality of DB-Users.

5. The system of claim 1, wherein the Software is configured to allow Device ordering privileges to be established for each of the plurality of DB-Users, the Device ordering privileges including the need for at least one additional approver to whom the order is automatically routed prior to allowing the DB-User to submit the order for procurement.

6. The system of claim 5, wherein the Software is configured to automatically remind the approver of each order awaiting approval from the approver.

7. The system of claim 5, wherein the Software is configured to maintain real time information on the status of the order.

8. The system of claim 1, wherein the Software is configured to maintain real time information on the status of the order.

9. The system of claim 1, wherein the Software is configured to produce reports with statistical information concerning at least one of: the orders placed by one or more DB-Users, time intervals within one or more ordering processes, the orders placed during a particular time period, the number of orders placed by Location, Devices ordered for particular Device-Users, and/or combinations thereof.

10. An interactive system for security management, the system accessible via a communications network by a plurality of DB-Users, the system comprising:
a plurality of security components used to control physical entry to different places,
at least one searchable database configured to store information on the DB-Users and the security components, and
Software configured to recognize different profiles established based on the information for different DB-Users wherein each profile defines an authority level of the corresponding DB-User including, for at least one of the DB-Users, the requirement for at least one approver in addition to said one DB-User necessary for submitting an order for one or more of the components of the security system.

11. The system of claim 10, wherein the Software is configured to direct the order through a plurality of separate approvers of the order.

12. The system of claim 10, wherein the approvers are in a hierarchy such that a first one of the approvers must approve the order before the order is forwarded on to a second one of the approvers.

13. The system of claim 10, wherein the at least one searchable database stores information defining which Devices may be ordered by each of the plurality of DB-Users.

14. The system of claim 10, wherein the Software is configured to allow Device ordering privileges to be established for each of the plurality of DB-Users, the Device ordering privileges including the need for at least one additional approver to whom the order is automatically routed prior to allowing the DB-User to submit the order for procurement.

15. The system of claim 14, wherein the Software is configured to automatically remind the approver of each order awaiting approval from the approver.

16. The system of claim 14, wherein the Software is configured to maintain real time information on the status of the order.

17. The system of claim 10, wherein the Software is configured to maintain real time information on the status of the order.

18. The system of claim 10, wherein the Software is configured to produce reports with statistical information concerning at least one of: the orders placed by one or more DB-Users, time intervals within one or more ordering processes, the orders placed during a particular time period, the number of orders placed by Location, Devices ordered for particular Device-Users, and/or combinations thereof.

19. A method for managing access to information concerning a security system by a plurality of DB-Users, the security system configured to physically secure a plurality of places with a corresponding plurality of security components used to control physical entry to the places, the method comprising:
using Software to place an order for at least one of the components of the security system in accordance with authority granted in a security component ordering profile stored in a database, and
using the Software to forward the order on to at least one approver for approving the order prior to submitting the order for procurement.

20. The method of claim 19, further comprising:
using the Software to forward the order on to a plurality of approvers for approving the order prior to submitting the order for procurement.

21. The method of claim 20, wherein a first one of the plurality of approvers must approve the order prior to the Software forwarding the order on to a second one of the plurality of approvers.

22. The method of claim 19, further comprising:
using the Software to automatically remind the approver that the order is awaiting approval.

23. The method of claim 19, further comprising:
using the Software to generate a report showing the status of the order.

24. The method of claim 23, wherein the report shows whether the approver has approved the order.

25. The method of claim 19, further comprising:
using the Software to generate a report with statistical information concerning at least one of: the orders placed by one or more DB-Users, time intervals within one or more ordering processes, the orders placed during a particular time period, the number of orders placed by Location, Devices ordered for particular Device-Users, and/or combinations thereof.
